(19) United States
(12) Patent Application Publication
(10) Pub. No.: US 2006/0091684 A1
(43) Pub. Date: May 4, 2006

(54) Tongs

(76) Inventor: Jasmina Frauscher, Salzburg (AT)

Correspondence Address: WILLIAM COLLARD;COLLARD & ROE, P.C., 1077 NORTHERN BOULEVARD, ROSLYN, NY, 11576, US

(21) Appl. No.: 10/545,363

(22) PCT Filed: Jan. 23, 2004
(86) PCT No.: PCT/AT04/00024

§ 371 Date: Aug. 11, 2005

(30) Foreign Application Priority Data
Feb. 12, 2003 (AT) GM/69/2003

(51) Int. Cl. B25B 9/00

(52) U.S. Cl. 294/99.2

(57) ABSTRACT

The invention relates to a simple method for producing tongs (1) and to a tong (1) comprising two arms (2) consisting of wooden material that can be elastically bent in relation to one another, said arms (2) being rigidly inserted into a head piece (3) at an angle to on another. To obtain an advantageous construction, each arm (2) is inserted into a respective groove of the wooden head piece (3), said V-shaped grooves being angled towards one another and both arms are connected to the head piece (3) in a permanent manner.

### FIELD OF THE INVENTION

The invention refers to a tong comprising two arms consisting of wooden material that can be elastically bent in relation to one another, said arms being rigidly inserted into a head piece at an angle to on another.

### DESCRIPTION OF THE PRIOR ART

In order to seize meals tongs are known (DE 442 855 B) comprising two arms consisting of wooden material that can be elastically bent in relation to one another, which are inserted into a conical head piece made of metal. Due to the form of the head piece and due to a cross strut at the open end of the cone surface area, the arms are rigidly inserted into a head piece at an angle to on another, whereby the head piece is hollow inside. However a disadvantage about this tong is, that the tong arms are easily detachable, since the tong arms fit only over small bearing surfaces inside the head piece. Repeated holding of meals leads soon to an enlargement of the axial play, so the necessary rigidly support is no longer given. In addition the production of a conical head piece is complex and cost-intensive, as besides of the complexity of the form a cross strut needs to be introduced at the open end of the cone surface area.

Furthermore tongs are known (U.S. Pat. No. 5,054,835 B), said tongs exhibits serving members held together with a head piece designed as sleeve. The serving members are inserted into the head piece in parallel manner, whereas this head piece holds the serving members together with a snap-fittingly engagement. A disadvantage with using these tongs is, that with reduction of the spring force of the snap-fittingly engagement, it can't be excluded that a release of the serving members from the head piece takes place when holding meals. In addition the spring force of the snap-fittingly engagement isn't a rigidly insertion of the serving members into a head piece, that gives a feeling of a sensitive holding of meals with tong arms. Also for the head piece regenerating materials, like wooden materials, can be used only at high production expenditure, which doesn't allow economical manufacturing of such tongs.

Other tongs (DE 75 02 395 U) consist of a head piece and two serving members. Thus a head piece is shown (FIG. 9), which takes two serving members rigidly inserted at an angle to on another. For this purpose two hole-like recesses like drillings are introduced into the head piece, said recesses go through the whole head pieces. In this recesses the serving members are inserted. A disadvantage is, that the bending forces upon the serving members have to be taken from the covering of the head piece lateral to the drillings, which demands an increased expenditure for material. Also the width of the head piece has to be larger designed than the width of the tong arms, therefore narrow tongs can't be produced with such a head piece. In addition a rectangular recess demands a comparatively high expenditure to be manufactured into wooden head piece, so such tong are not usable for one-way tongs.

### SUMMARY OF THE INVENTION

It is one object of the present invention to improve a tong as well as to improve a production of a tong, in such a manner that despite a high load capacity of the tongs the tongs can be produced economically from regenerating materials. In addition the tong should distinguish to other tongs in ability of recycling and in smallest dimensions.

The object is achieved by the present invention in such a way that each arm is inserted into a respective groove of the wooden head piece, said V-shaped grooves being angled towards one another and both arms are connected to the head piece in a permanent manner.

As the tong arms are inserted into a respective groove of a head piece, said V-shaped grooves being angled towards one another, the tong arms rigidly support themselves over enough large bearing surfaces in the head piece, which leads to no axial play even with frequent bending of the tong arms. Therefore less resistant materials, for example wood materials, can be used, without a danger of detaching the tong arms from the head piece. In order to prevent also a lateral shifting of the tong arms in the respective groove, the tong arms with the head piece are connected in a permanent manner, which excludes additionally an axial play caused by production also. Since now all tongs can be manufactured from wooden material, a complex recycling technique for the tongs is not needed, what allows the tongs to act as a one-way tong. As now it is possible to choose the width of the head piece equally to the width of the tong arms, particularly apart from a decrease of the expenditure for material and supplies slim tongs are available.

With grooves located in the front part of the tongs, whereby the inside the tong arms exhibit these grooves, meals can be improved secured.

If each tong arm carries a ramp on it's inside, said ramp is dropping to the jaw of the tong, meals held together can be simple separated. Also meals can be better seized with putting the tong arms underneath the meals.

With providing grooves into the head piece of the tong, a tong can be particularly simple and economical manufacture from wooden material. Thus in a first step a elastically bendable wooden plate is inserted into a respective groove of a wooden strip with profile, said V-shaped grooves being angled towards one another and both plates are connected in a permanent manner. In a further step at least one tongs can be separated. This can be done with a cut crosswise to the strip with profile, said cut position is depended on the width of the tong arms.

### BRIEF DESCRIPTION OF THE DRAWINGS

The subject matter of the invention is shown by the way of example in the drawings.

FIG. 1 shows a tong according to invention in three-dimensional view and

FIG. 2 a side view upon FIG. 1.

### DESCRIPTION OF THE PREFERRED EMBODIMENT

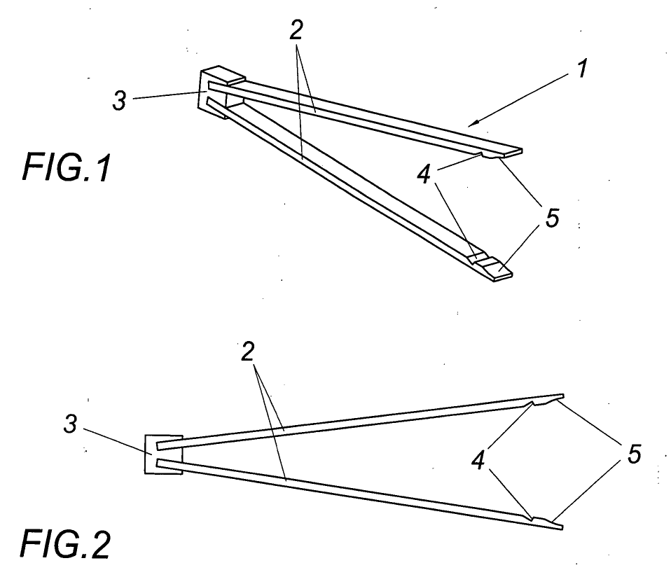

According to the illustrated embodiment the tong 1 (FIG. 1, FIG. 2) comprises two arms 2 consisting of wooden material that can be elastically bent in relation to one another and a wooden head piece 3. The tong arms 2 being rigidly inserted each into a groove of a head piece 3 at an angle to on another. Said grooves of the wooden head piece 3 are V-shaped and being angled towards one another (FIG. 2) and separated. Therefor a space is formed in the head piece 3 for sufficient strength. In order to prevent a shifting of the tong arms 2 in the respective groove, the tong arms 2 connected to the head piece 3 in a permanent manner, for example with glue.

The tong 1 exhibit on the inside the tong arms 2 grooves 4, said grooves 4 are located in the open front part of the tong 1. Also on the inside each tong arm 2 carries a ramp 5, said ramp 5 starting from the inside of the tong arms 2 is dropping down to the jaw of the tong 1, in order to improve seizing of meals. In addition the head piece 3 width is the same as for the tong arms 2, so that the tong is particularly comfortable 1 in it's handling.

Since the head piece 3 is made of wood material, the head piece 3 can be favourably separated from a strip with profile, in which two grooves are in-milled. The tong arms 2 must be only inserted then into the head piece 3.

However especially easy and economically the production of the tongs 1 by technique is, with a separation cut after insertion the tong arms 2 into the head piece 3. Therefor the individual manufacturing of the tong arms 2 as well as insertion of the two tong arms 2 into the head piece 3 can be avoided.

1. Tong comprising two arms (2) consisting of wooden material that can be elastically bent in relation to one another, said arms (2) being rigidly inserted into a head piece (3) at an angle to on another, wherein each arm (2) is inserted into a respective groove of the wooden head piece (3), said V-shaped grooves being angled towards one another and both arms (2) are connected to the head piece (3) in a permanent manner.

2. Tong according to claim 1, wherein on the inside the tong arms (2) exhibit grooves (4), said grooves (4) are located in the open front part of the tong (1).

3. Tong according to claim 1, wherein on the inside each tong arm (2) carries a ramp (5), said ramp (5) starting from the inside of the tong arms (2) is dropping down to the jaw of the tong (1).

4. Method for producing tongs, wherein in a first step a elastically bendable wooden plate is inserted into a respective groove of a wooden strip with profile, said V-shaped grooves being angled towards one another and both plates are connected in a permanent manner, and in a further step at least one tong (1) is separated with a cut crosswise to the strip with profile, said cut position is depended on the width of the tong arms (2).
